(19) United States
(12) Patent Application Publication
(10) Pub. No.: US 2024/0101381 A1
(43) Pub. Date: Mar. 28, 2024

(54) SHEET TRANSPORTING DEVICE AND IMAGE FORMING APPARATUS

(71) Applicant: FUJIFILM Business Innovation Corp., Tokyo (JP)

(72) Inventors: Yasunobu GOTO, Kanagawa (JP); Kiyoshi WATANABE, Kanagawa (JP); Yoshinori KOIKE, Kanagawa (JP); Hirotake EGUCHI, Kanagawa (JP); Yuki KAWAZOE, Kanagawa (JP); Shuhei KOBORI, Kanagawa (JP)

(73) Assignee: FUJIFILM Business Innovation Corp., Tokyo (JP)

(21) Appl. No.: 18/189,208

(22) Filed: Mar. 24, 2023

(30) Foreign Application Priority Data
Sep. 28, 2022 (JP) 2022-155016

(51) Int. Cl. B65H 9/10; B65H 9/08; G03G 15/00

(52) U.S. Cl. CPC B65H 9/103; B65H 9/08; G03G 15/6561; G03G 15/6567; B65H 7/10; B65H 2801/06; G03G 2215/00468; G03G 2215/00721

(57) ABSTRACT

A sheet transporting device includes first and second position correcting components provided at respective positions in a direction of sheet transport and each being configured to correct a position of a sheet in a direction intersecting the direction of sheet transport by being shifted in the direction intersecting the direction of sheet transport while holding the sheet, and a changing component capable of changing an amount of correction of the position of the sheet individually for the first and second position correcting components.

### CROSS-REFERENCE TO RELATED APPLICATIONS

This application is based on and claims priority under 35 USC 119 from Japanese Patent Application No. 2022-155016 filed Sep. 28, 2022.

### BACKGROUND

### (i) Technical Field

The present disclosure relates to a sheet transporting device and an image forming apparatus.

### (ii) Related Art

Hitherto proposed techniques relating to sheet transporting devices include the one disclosed by Japanese Unexamined Patent Application Publication No. 2019-147663, for example.

According to Japanese Unexamined Patent Application Publication No. 2019-147663, a sheet that is nipped by two pairs of nip-transporting members is first moved in the width direction, two nip-transporting members forming one of the two pairs of nip-transporting members that is located on the upstream side in the transporting direction are then moved away from each other, and the sheet is transported by the other of the two pairs of nip-transporting members that is located on the downstream side in the transporting direction.

### SUMMARY

Aspects of non-limiting embodiments of the present disclosure relate to increasing the accuracy in the correction of the position of the sheet, compared with a case where the amount of correction of the position of the sheet is determined uniformly for first and second position correcting components.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a sheet transporting device including first and second position correcting components provided at respective positions in a direction of sheet transport and each being configured to correct a position of a sheet in a direction intersecting the direction of sheet transport by being shifted in the direction intersecting the direction of sheet transport while holding the sheet, and a changing component capable of changing an amount of correction of the position of the sheet individually for the first and second position correcting components.

### BRIEF DESCRIPTION OF THE DRAWINGS

An exemplary embodiment of the present disclosure will be described in detail based on the following figures, wherein:

FIG. 1 illustrates an overall configuration of an image forming apparatus to which a sheet transporting device according to the exemplary embodiment of the present disclosure is applied;

FIG. 2 illustrates a configuration of a relevant part of a paper transporting device serving as an exemplary sheet transporting device according to the exemplary embodiment of the present disclosure;

FIG. 3 is a plan view of pairs of paper transporting rolls;

FIG. 4 is a sectional view of one of the pairs of paper transporting rolls and relevant elements;

FIG. 5 is a plan view of other pairs of paper transporting rolls;

FIG. 6 is a sectional view of one of the pairs of paper transporting rolls and relevant elements;

FIG. 7 is a perspective view of a skew correcting device;

FIG. 8 is a sectional view of the skew correcting device;

FIG. 9 is a block diagram of a control device included in the image forming apparatus to which the sheet transporting device according to the exemplary embodiment of the present disclosure is applied;

FIGS. 10A to 10H illustrate how long-size paper is transported in the image forming apparatus to which the sheet transporting device according to the exemplary embodiment of the present disclosure is applied; and

FIG. 11 illustrates an operation of the paper transporting device serving as an exemplary sheet transporting device according to the exemplary embodiment of the present disclosure.

### DETAILED DESCRIPTION

### Exemplary Embodiment

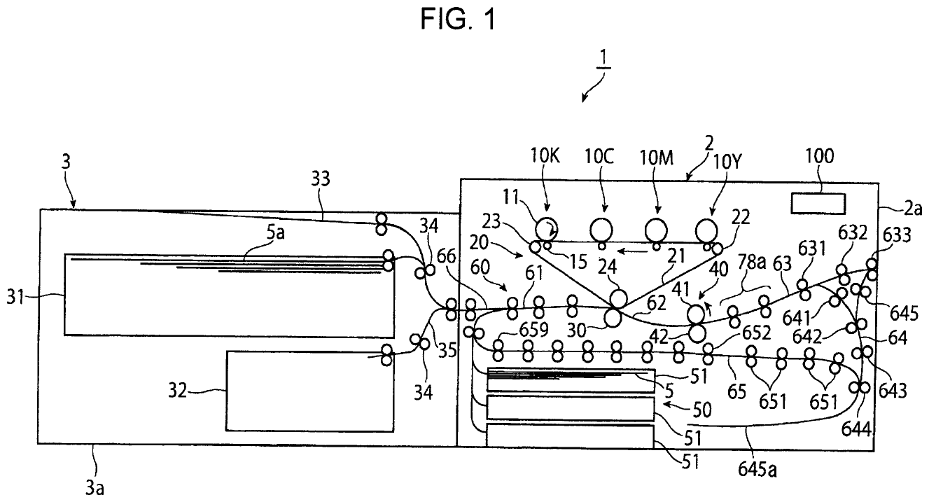

FIG. 1 illustrates the entirety of an image forming apparatus 1 to which a sheet transporting device according to an exemplary embodiment of the present disclosure is applied.

### Overall Configuration of Image Forming Apparatus

The image forming apparatus 1 according to the present exemplary embodiment is configured as, for example, a color printer. As illustrated in FIG. 1, the image forming apparatus 1 includes an image output device 2, which is configured to form (output) a full-color image composed of different colors such as yellow (Y), magenta (M), cyan (C), and black (K) on recording paper 5, which is an exemplary recording medium (sheet); and a paper feeding device 3, which is a stand-alone device configured to feed long-size recording paper (hereinafter referred to as “long-size paper”) or the like to the image output device 2. The paper feeding device 3 is located outside the image output device 2 and adjoins the image output device 2.

The image output device 2 includes a plurality of imaging devices 10, which are exemplary image forming component and are configured to form toner images developed with toners contained in developers; an intermediate transfer device 20, which is configured to receive the toner images formed by the imaging devices 10 and transport the toner images to a second-transfer position, where the toner images are eventually transferred to the recording paper 5 as an exemplary recording medium (sheet) in a second-transfer process; a paper feeding device 50, which contains predetermined pieces of recording paper 5 to be supplied to the second-transfer position defined in the intermediate transfer device 20 and is configured to feed each of the pieces of recording paper 5; a fixing device 40, which is configured to fix the toner images on the recording paper 5 having undergone the second-transfer process performed by the intermediate transfer device 20; and a paper transporting device 60, which is an exemplary sheet transporting device (sheet transporting component) and is configured to receive the recording paper 5 from the paper feeding device 50 and transport the recording paper 5 along a predetermined transport path. The image output device 2 has a device body 2a. The device body 2a includes supporting members, exterior coverings, and so forth. In FIG. 1, transport paths along which the recording paper 5 is to be transported in the device body 2a and other locations are represented by solid lines.

The imaging devices 10 are four imaging devices 10Y, 10M, 10C, and 10K, which are configured to exclusively form respective toner images in four respective colors of yellow (Y), magenta (M), cyan (C), and black (K). The four imaging devices 10 (Y, M, C, and K) are arranged in a line and at predetermined intervals in the horizontal direction in the device body 2a.

The four imaging devices 10 each include, for example, a photoconductor drum 11, and imaging elements (not illustrated) that are provided around the photoconductor drum 11 and cooperate to form a toner image in a corresponding one of the predetermined colors on the surface of the photoconductor drum 11, whereby the imaging devices 10 electrophotographically form respective images in the respective colors of yellow (Y), magenta (M), cyan (C), and black (K) on the surfaces of the respective photoconductor drums 11. The four imaging devices 10 are not limited to devices employing an electrophotographic scheme to form images and may be devices employing any other scheme such as an inkjet recording scheme or electrostatic recording scheme to form images in respective colors such as yellow (Y), magenta (M), cyan (C), and black (K). If the imaging devices 10 employ an inkjet recording scheme to form images, the intermediate transfer device 20 is omitted; that is, the imaging devices 10 form images directly on the recording paper 5. In such a case, imaging devices configured to form images in the respective colors such as yellow (Y), magenta (M), cyan (C), and black (K) by an inkjet recording scheme are aligned in the direction of transport of the recording paper 5.

As illustrated in FIG. 1, the intermediate transfer device 20 is located below the imaging devices 10 (Y, M, C, and K) for yellow (Y), magenta (M), cyan (C), and black (K) in the vertical direction. The intermediate transfer device 20 includes an intermediate transfer belt 21, which is to be rotated in the direction of the arrow in such a manner as to pass through first-transfer positions defined between the photoconductor drums 11 and respective first-transfer devices 15 (first-transfer rolls); a plurality of belt supporting rolls 22 to 24, which support the intermediate transfer belt 21 from the inner side such that the intermediate transfer belt 21 is retained in a predetermined position while being allowed to rotate; and a second-transfer device 30, which faces the outer peripheral surface (an image-carrying surface) of the intermediate transfer belt 21 at a position across from the belt supporting roll 24 and is configured to transfer a set of toner images from the intermediate transfer belt 21 to the recording paper 5 in the second-transfer process.

The fixing device 40 has a housing (not illustrated) having an introduction port and a discharge port for the recording paper 5 and that houses elements including the following: a heating rotary member 41, which is in the form of a roll or belt and is configured to rotate in the direction of the arrow and to be heated by a heating component such that the surface thereof is kept at a predetermined temperature; and a pressing rotary member 42, which is in the form of a belt or roll and is configured to rotate by being in contact with the heating rotary member 41 with a predetermined pressure over an area extending substantially in the axial direction of the heating rotary member 41. In the fixing device 40, the contact area where the heating rotary member 41 and the pressing rotary member 42 are in contact with each other serves as a fixing part, where a predetermined fixing process (heating and pressing) is to be performed.

As illustrated in FIG. 1, the paper feeding device 50 is located below the intermediate transfer device 20 and the second-transfer device 30. The paper feeding device 50 includes a plurality of paper containers 51 (or a single paper container 51), which each contain a stack of pieces of recording paper 5 that are of one predetermined size, kind, or the like; and delivering devices (not illustrated), which are each configured to deliver the pieces of recording paper 5 one by one from a corresponding one of the paper containers 51. The paper containers 51 are each drawable from, for example, the front face of the device body 2a (the face toward which the user who is operating the image output device 2 faces).

The stand-alone paper feeding device 3 includes a paper container 31 and a large-capacity paper container 32. The paper container 31 contains a stack of pieces of long-size paper 5a. The long-size paper 5a has a greater length in a direction of paper feeding and/or a direction intersecting the direction of paper feeding than the recording paper 5 of size A3, which is the largest one of standard sizes typically handled by the image forming apparatus 1. The large-capacity paper container 32 is capable of containing a greater number of pieces of recording paper 5 of a standard size than the paper containers 51, which are typically used. The paper feeding device 3 further includes a paper tray 33, which is provided at the top of a device body 3a and is intended for manual feeding of the long-size paper 5a or the like.

The paper transporting device 60 includes a paper feeding path 61, along which recording paper 5 fed from the paper feeding device 50 is transported to the second-transfer position; an intermediate transport path 62, along which the recording paper 5 having received a set of toner images at the second-transfer position in the second-transfer process is transported to the fixing device 40; an outputting transport path 63, along which the recording paper 5 having the set of toner images fixed by the fixing device 40 is transported to a paper receiving member (not illustrated); a reversal transport path 64, along which the recording paper 5 having the set of toner images fixed by the fixing device 40 is reversed before being outputted to the paper receiving member; and a duplex transport path 65, along which the recording paper 5 reversed in the reversal transport path 64 is transported to the paper feeding path 61 again for an image forming process to be performed on the other side of the recording paper 5. Details of the paper transporting device 60 will be described separately below.

The stand-alone paper feeding device 3 includes a paper feeding path 35, which is provided with pairs of paper transporting rolls 34. The long-size paper 5a or recording paper 5 that is fed from any of the paper container 31, the large-capacity paper container 32, and the manual-feeding paper tray 33 is transported by the pairs of paper transporting rolls 34 to an external-paper feeding path 66, which is provided in the image output device 2.

An overall operation of the image forming apparatus 1 inclusive of the paper feeding device 3 is controlled by a control device 100, illustrated in FIG. 1. To control the overall operation of the image forming apparatus 1 inclusive of the paper feeding device 3, the control device 100 acknowledges the size or kind of the recording paper 5 informed of by the user's instruction or the like and controls transporting operations including an operation of correcting any skew of the recording paper 5.

### Basic Operation of Image Forming Apparatus

A basic image forming operation performed by the image forming apparatus 1 will now be described.

The following description relates to an image forming operation in which a full-color image composed of toner images having the four respective colors (Y, M, C, and K) is formed by using the four imaging devices 10 (Y, M, C, and K).

When the control device 100 of the image forming apparatus 1 receives a command that requests an image forming operation (printing operation), the control device 100 activates the four imaging devices 10 (Y, M, C, and K), the intermediate transfer device 20, the second-transfer device 30, the fixing device 40, the paper feeding device 50, the paper transporting device 60, and other relevant devices.

First, in the imaging devices 10 (Y, M, C, and K), toner images in the respective colors of yellow (Y), magenta (M), cyan (C), and black (K) are formed on the respective photoconductor drums 11. The toner images in the respective colors thus formed on the photoconductor drums 11 of the imaging devices 10 (Y, M, C, and K) are carried to the respective first-transfer positions, where the first-transfer devices 15 perform a first-transfer process, in which the toner images in the respective colors are sequentially superposed one on top of another on the intermediate transfer belt 21 of the intermediate transfer device 20 that is rotating in the direction of the arrow.

Subsequently, in the intermediate transfer device 20, the intermediate transfer belt 21 having received the set of toner images in the first-transfer process rotates to transport the set of toner images to the second-transfer position. Meanwhile, in the paper feeding device 50, a predetermined piece of recording paper 5 is fed into the paper feeding path 61 synchronously with the imaging process. In the paper feeding path 61, the piece of recording paper 5 is supplied to the second-transfer position synchronously with the timing of transfer.

At the second-transfer position in the intermediate transfer device 20, the second-transfer device 30 performs the second-transfer process in which the set of toner images is transferred from the intermediate transfer belt 21 to the piece of recording paper 5. The piece of recording paper 5 now having the set of toner images received in the second-transfer process is released from the intermediate transfer belt 21 and the second-transfer device 30 and is transported to the fixing device 40. In the fixing device 40, the piece of recording paper 5 having undergone the second-transfer process is made to pass through the fixing part defined between the heating rotary member 41 and the pressing rotary member 42 that are rotating, whereby the set of unfixed toner images are fixed to the piece of recording paper 5 through the predetermined fixing process (heating and pressing). The piece of recording paper 5 having undergone the fixing process is transported along the outputting transport path 63 to, for example, the paper receiving member (not illustrated) provided on the outside of the image output device 2.

If an image is to be formed on each of the two sides of the piece of recording paper 5, the piece of recording paper 5 having an image on one side thereof is not immediately discharged to the paper receiving member (not illustrated) through the outputting transport path 63 but is redirected toward the reversal transport path 64 by a redirecting component (not illustrated). As the piece of recording paper 5 is transported along the reversal transport path 64, the front and back sides of the piece of recording paper 5 are reversed. Then, the piece of recording paper 5 is transported along the duplex transport path 65 to the paper feeding path 61 again for the operation of forming an image on the back side of the piece of recording paper 5.

If an image is to be formed on one side or each of the two sides of a piece of long-size paper 5a or the like that is fed from the external paper feeding device 3, the paper feeding device 3 operates as follows: a piece of recording paper 5, such as long-size paper 5a, is fed to the paper feeding path 35 synchronously with the imaging process and is transported along the paper feeding path 35 to the external-paper feeding path 66 provided in the image output device 2.

Through the above series of processes, a piece of recording paper 5 having a full-color image formed as a combination of toner images in the four respective colors is obtained.

### Configuration of Sheet Transporting Device

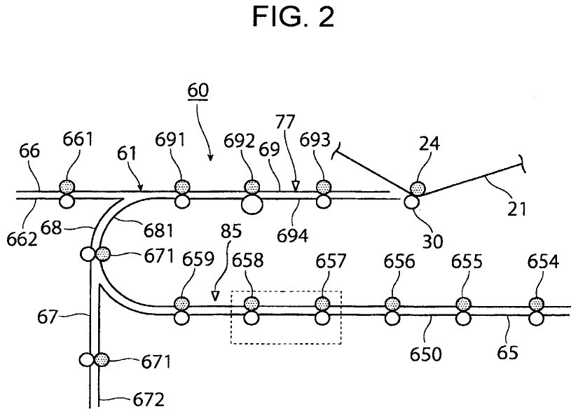

FIGS. 1 and 2 illustrate the configuration of the image forming apparatus to which the paper transporting device 60 serving as an exemplary sheet transporting device according to the exemplary embodiment of the present disclosure is applied.

The paper transporting device 60 according to the present exemplary embodiment is provided inside the device body 2a of the image output device 2. As illustrated in FIG. 1, the paper transporting device 60 includes the paper feeding path 61 along which recording paper 5 fed from the paper feeding device 50 is transported to the second-transfer position in the intermediate transfer device 20, the intermediate transport path 62 along which the recording paper 5 having received a set of toner images at the second-transfer position in the intermediate transfer device 20 is transported to the fixing device 40, the outputting transport path 63 along which the recording paper 5 having the set of toner images fixed by the fixing device 40 is transported to the paper receiving member (not illustrated), the reversal transport path 64 along which the recording paper 5 having the set of toner images fixed by the fixing device 40 is reversed before being outputted to the paper receiving member, the duplex transport path 65 along which the recording paper 5 reversed in the reversal transport path 64 is transported through the paper feeding path 61 to the second-transfer position in the intermediate transfer device 20 again, and the external-paper feeding path 66 that is a short path along which recording paper 5, such as long-size paper 5a, fed from the external paper feeding device 3 is transported to the paper feeding path 61.

As illustrated in FIG. 2, the paper feeding path 61 includes a vertical transport path 67, which extends vertically to allow the recording paper 5 fed from the paper feeding device 50 to be transported upward in the vertical direction; a curved transport path 68, in which the recording paper 5 transported upward in the vertical direction along the vertical transport path 67 is redirected to be transported in the horizontal direction; and a horizontal transport path 69, along which the recording paper 5 redirected along the curved transport path 68 to be transported in the horizontal direction is transported to the second-transfer position in the intermediate transfer device 20.

The vertical transport path 67 included in the paper feeding path 61 is provided with pairs of paper transporting rolls 671, which transport the recording paper 5; and a guide member 672, which guide the front and back sides of the recording paper 5. The curved transport path 68 included in the paper feeding path 61 is provided with a curved guide member 681, which is curved and guides the front and back sides of the recording paper 5.

The horizontal transport path 69 included in the paper feeding path 61 is provided with a plurality (three in the case illustrated in the drawings) of pairs of paper transporting rolls 691 to 693, which transport the recording paper 5 while nipping the recording paper 5; and a guide member 694, which guides the front and back sides of the recording paper 5. Among the three pairs of paper transporting rolls 691 to 693, the pair of paper transporting rolls 693 located at the downstreammost position and immediately before the second-transfer position in the intermediate transfer device 20 serves as a pair of first shift rolls configured to cause the recording paper 5 to undergo a translational movement (to be shifted) in a scanning direction that intersects the direction of transport of the recording paper 5.

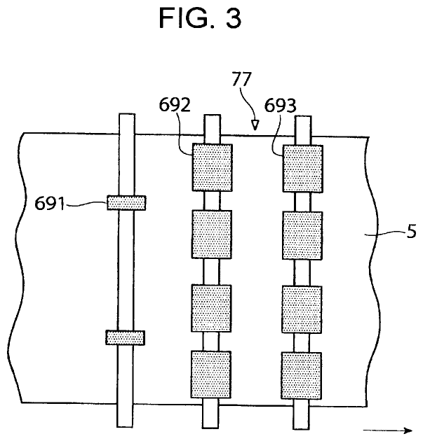

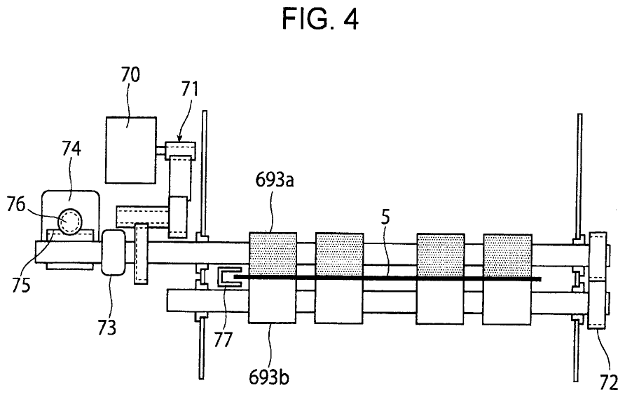

Referring to FIGS. 3 and 4, the pair of paper transporting rolls 693 serving as the pair of first shift rolls includes a driving roll 693a, which is rotated by a driving motor 70 through a reduction gear train 71; and a follower roll 693b, which is pressed against the driving roll 693a and receives a driving force from the driving roll 693a through a transmitting gear 72. The driving roll 693a is provided at one end in the axial direction thereof with a bearing 73 and is movable together with the follower roll 693b in the axial direction thereof by a moving mechanism that includes a driving motor 74, a rack 75, and a pinion 76, while the movable range of the driving roll 693a in the thrust direction is restricted by the bearing 73. A first detector 77 is provided on the upstream side relative to the pair of paper transporting rolls 693 in the direction of transport of the recording paper 5. The first detector 77 is an in-line sensor or the like and is configured to detect the position of the leading end of the recording paper 5 that extends in the direction intersecting the direction of transport of the recording paper 5.

Among the three pairs of paper transporting rolls 691 to 693, the pair of paper transporting rolls 692 located on the upstream side relative to the pair of paper transporting rolls 693 serves as a pair of registration rolls configured to adjust the timing of transport of the recording paper 5 to the second-transfer position. Among the three pairs of paper transporting rolls 691 to 693, the pair of paper transporting rolls 691 located at the upstreammost position cooperates with the other pairs of paper transporting rolls 692 and 693 to transport the recording paper 5.

While the pair of paper transporting rolls 693 serving as the pair of first shift rolls adjusts the position of the recording paper 5 in the scanning direction intersecting the direction of transport, the nipping of the recording paper 5 by the pairs of paper transporting rolls other than the pair of transporting rolls 693 is disabled.

Referring to FIG. 1, the intermediate transport path 62 is intended to transport the recording paper 5 having a set of unfixed toner images and is provided with a plurality of or a single transporting belt or the like (not illustrated), with which the recording paper 5 is transported to the fixing device 40. On the downstream side relative to the fixing device 40 in the direction of transport is provided a decurling device 78a, which is configured to decurl the recording paper 5.

The outputting transport path 63 is provided with a plurality (three in the case illustrated in FIG. 1) of pairs of paper outputting rolls 631 to 633, with which the recording paper 5 having undergone the fixing process performed by the fixing device 40 is immediately discharged to the outside.

Among the three pairs of paper outputting rolls 631 to 633 provided to the outputting transport path 63, the pair of paper outputting rolls 631 is located at the upstreammost position in the direction of transport of the recording paper 5. On the downstream side relative to the pair of paper outputting rolls 631 are provided a plurality of pairs of paper transporting rolls 641 to 644, with which the recording paper 5 that is redirected by a redirecting component (not illustrated) configured to change the direction of transport of the recording paper 5 is transported along the reversal transport path 64. The reversal transport path 64 extends toward the downstream side in the direction of transport by the plurality of pairs of paper transporting rolls 641 to 644 and further extends below the duplex transport path 65 to form an end portion 645a. The direction of rotation of the plurality of pairs of paper transporting rolls 642 to 644 provided to the reversal transport path 64 is switchable between the forward direction and the backward direction. When the recording paper 5 is temporarily transported into the reversal transport path 64 and the plurality of pairs of paper transporting rolls 642 to 644 are then rotated backward, the recording paper 5 is discharged from the reversal transport path 64 and is transported by the pair of output rolls 645 to the paper receiving member (not illustrated), with the front and back sides thereof reversed.

On the other hand, when the recording paper 5 is temporarily transported into the reversal transport path 64 and the pair of paper transporting rolls 644 is then rotated backward, the recording paper 5 is redirected by a redirecting component (not illustrated) toward the duplex transport path 65.

As illustrated in FIGS. 1 and 2, the duplex transport path 65 is provided with a plurality of pairs of paper transporting rolls 651 to 659, which transport the recording paper 5; and a guide member 650, which guides the front and back sides of the recording paper 5. Among the plurality of pairs of paper transporting rolls 651 to 659, the pair of paper transporting rolls 659 located at the downstreammost position and immediately before the paper feeding path 61 serves as a pair of second shift rolls configured to cause the recording paper 5 to undergo a translational movement (to be shifted) in the scanning direction intersecting the direction of transport.

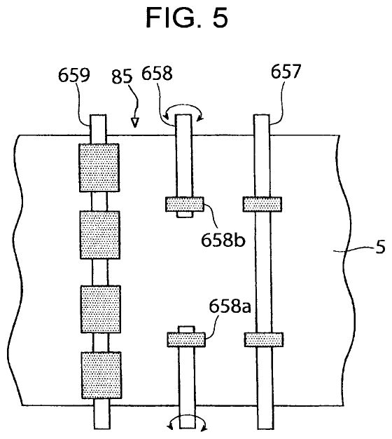

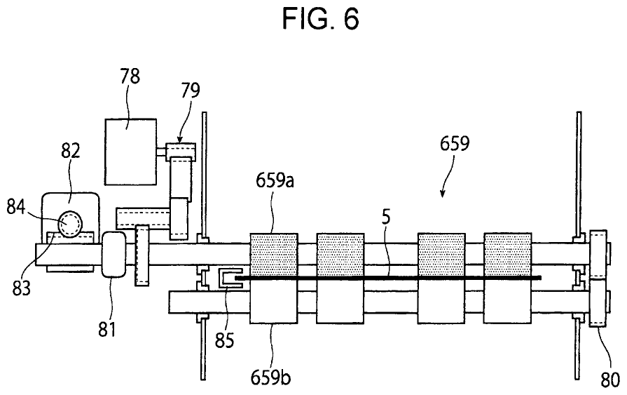

Referring to FIGS. 5 and 6, the pair of paper transporting rolls 659 serving as the pair of second shift rolls has the same configuration as the pair of paper transporting rolls 693 serving as the pair of first shift rolls. Specifically, the pair of paper transporting rolls 659 serving as the pair of second shift rolls includes a driving roll 659a, which is rotated by a driving motor 78 through a reduction gear train 79; and a follower roll 659b, which is pressed against the driving roll 659a and receives a driving force from the driving roll 659a through a transmitting gear 80. The driving roll 659a is provided at one end in the axial direction thereof with a bearing 81 and is movable together with the follower roll 659b in the axial direction thereof by a moving mechanism that includes a driving motor 82, a rack 83, and a pinion 84, while the movable range of the driving roll 659a in the thrust direction is restricted by the bearing 81.

Among the three pairs of paper transporting rolls 657 to 659, the pair of paper transporting rolls 658 located on the upstream side relative to the pair of paper transporting rolls 659 serves as a pair of skew correcting rolls, which is an exemplary skew correcting component and is configured to correct any skew of the recording paper 5.

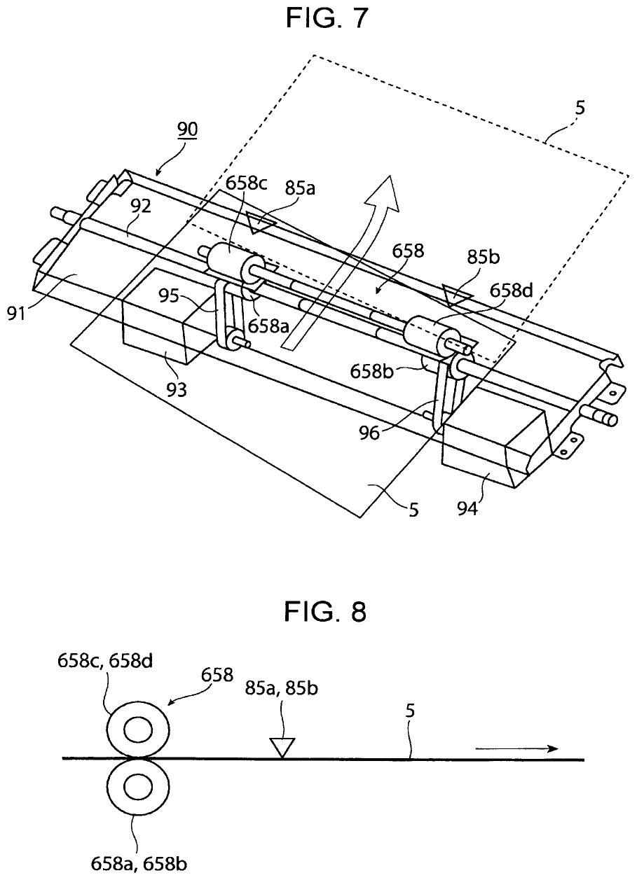

Referring to FIGS. 7 and 8, the pair of paper transporting rolls 658 includes a first driving roll 658a, which is an exemplary first transporting component and is located on the front side in the axial direction (width direction) intersecting the direction of transport of the recording paper 5; and a second driving roll 658b, which is an exemplary second transporting component and is located on the rear side in the axial direction. The amounts of rotation (rotation speeds) of the first driving roll 658a and the second driving roll 658b are controllable independently of each other. The pair of paper transporting rolls 658 further includes on the upper side thereof follower rolls 658c and 658d, which are arranged at respective positions in the axial direction and are rotatable independently of each other.

The first and second driving rolls 658a and 658b are rotatable independently of each other on a rotation shaft 92, which is fixed to or rotatably attached to the housing, 91, of a skew correcting device 90. The first and second driving rolls 658a and 658b are to be rotated independently of each other by first and second driving motors 93 and 94 with the aid of respective driving belts 95 and 96 at respective predetermined rotation speeds. The first and second follower rolls 658c and 658d are in contact with the first and second driving rolls 658a and 658b from above, thereby being rotatable independently of each other. The pair of paper transporting rolls 658 is configured to correct any skew of the recording paper 5 while nipping the recording paper 5, with the individual amounts of rotation (rotation speeds) of the first driving roll 658a and the second driving roll 658b changed.

On the downstream side relative to the pair of paper transporting rolls 658 in the direction of transport of the recording paper 5 are provided a pair of second detectors 85a and 85b (also collectively referred to as the second detector 85), which are each configured to detect the position of the leading end of the recording paper 5 that extends in the direction intersecting the direction of transport of the recording paper 5. The second detectors 85a and 85b are arranged at respective positions that are in bilateral symmetry with respect to the center of the recording paper 5 in the direction intersecting the direction of transport. The second detectors 85a and 85b each output a detection signal to the control device 100.

Among the three pairs of paper transporting rolls 657 to 659, the pair of paper transporting rolls 657 located at the upstreammost position cooperates with the pairs of paper transporting rolls 651 to 656 and other relevant elements to transport the recording paper 5.

Referring to FIG. 2, the external-paper feeding path 66 is provided with a pair of paper transporting rolls 661, which transports the recording paper 5 received from the external paper feeding device 3 while nipping the recording paper 5; and a guide member 662, which guides the front and back sides of the recording paper 5.

The image forming apparatus 1 to which the paper transporting device 60 configured as above is applied is capable of forming an image on the long-size paper 5a that is fed from the external paper feeding device 3 or the like. The long-size paper 5a does not necessarily need to be fed from the external paper feeding device 3 and may be fed from the inside of the image forming apparatus 1. The long-size paper 5a, which is exemplary recording paper 5, has a greater length in the direction of transport than the recording paper 5 of the standard size and therefore tends to cause lateral shift, in which the recording paper 5 that is being transported by the paper transporting device 60 moves in the direction intersecting the direction of transport, resulting in misregistration of the recording paper 5 in the direction intersecting the direction of transport. The long-size paper 5a is more likely to cause lateral shift leading to misregistration in the direction intersecting the direction of transport than the standard recording paper 5 particularly in duplex image formation, in which the recording paper 5 is to be transported along a long path. Specifically, the long-size paper 5a having an image on one side thereof is to be transported from the outputting transport path 63 and along the reversal transport path 64 for the reversal of the front and back sides thereof, and to be further transported along the duplex transport path 65 and the paper feeding path 61 to the second-transfer position in the intermediate transfer device 20.

In view of the above, as illustrated in FIG. 2 and described above, the paper transporting device 60 according to the present exemplary embodiment includes the pair of paper transporting rolls 659, serving as the pair of second shift rolls, at the downstreammost position of the duplex transport path 65 in the direction of transport of the recording paper 5, so that the position of the recording paper 5 in the direction intersecting the direction of transport is to be corrected by the pair of paper transporting rolls 659 cooperating with the pair of paper transporting rolls 693 serving as the pair of first shift rolls located at the downstreammost position of the paper feeding path 61 in the direction of transport of the recording paper 5.

However, a technical problem may occur in some cases including the following: a case where the recording paper 5 is long-size paper 5a having a greater length in the direction of transport than plain paper, a case where the recording paper 5 is cardboard having a greater basis weight (over 200 gsm, for example) than plain paper, a case where the recording paper 5 is embossed paper or the like having greater surface irregularities than plain paper and therefore exhibits poorer characteristics relevant to sheet transport than plain paper, and a case of the duplex image formation mode. Specifically, in the correction of lateral misregistration of the recording paper 5 by using the pair of paper transporting rolls 693 and the pair of paper transporting rolls 659 in the cases listed above, the presence of the curved part in the paper feeding path 61 and other relevant factors makes the contact resistance generated between the recording paper 5 and the guide member 681 and other relevant elements in the transporting process greater than in the case of plain paper. Therefore, it is difficult to fully correct the lateral misregistration of the recording paper 5 by moving the pair of paper transporting rolls 693 and the pair of paper transporting rolls 659 only by an amount equal to the amount for the case of plain paper, and the accuracy in the correction of lateral misregistration, or lateral skew, may thus be lowered.

In view of the above, the paper transporting device 60 according to the present exemplary embodiment includes a changing component capable of changing the amount of correction of the position of the sheet individually for the pair of paper transporting rolls 693 and the pair of paper transporting rolls 659, which are exemplary first and second position correcting components.

The changing component of the paper transporting device 60 according to the present exemplary embodiment is configured to change the amount of correction of the position of the sheet individually for the first and second position correcting components by multiplying the amount of shifting of each of the first and second position correcting components in the direction intersecting the direction of sheet transport by a correction factor.

The correction factor to be employed by the changing component of the paper transporting device 60 according to the present exemplary embodiment is greater for one of the first and second position correcting components that is located on the downstream side in the direction of sheet transport than for the other located on the upstream side.

The changing component of the paper transporting device 60 according to the present exemplary embodiment is configured to change the amount of correction of the position of the sheet individually for the first and second position correcting components with reference to any of characteristics relevant to sheet transport. The changing component refers to at least one of the following characteristics relevant to sheet transport: the length of the sheet in the direction of transport, the basis weight of the sheet, the material of the sheet, and the mode of sheet transport.

According to the present exemplary embodiment, referring to FIGS. 4 and 6, to correct the position of the recording paper 5 in the direction intersecting the direction of transport by using the pair of paper transporting rolls 693 and the pair of paper transporting rolls 659 of the paper transporting device 60, the first and second detectors 77 and 85 each detect the position of the recording paper 5 in the direction intersecting the direction of transport at a corresponding one of the pair of paper transporting rolls 693 and the pair of paper transporting rolls 659.

In response to the detection by the first and second detectors 77 and 85 for the correction of any misregistration of the recording paper 5 in the direction intersecting the direction of transport, the control device 100, which serves as an exemplary changing component, determines the amount of shifting of each of the pair of paper transporting rolls 693 and the pair of paper transporting rolls 659 by multiplying the amount of shifting that is set for the case of plain paper by a correction factor that is determined with reference to the characteristic relevant to sheet transport.

In general, if the recording paper 5 is plain paper or the like, the control device 100 is supposed to determine the amounts of shifting of the pair of paper transporting rolls 693 and the pair of paper transporting rolls 659, illustrated in FIGS. 4 and 6, in such a manner as to shift the pair of paper transporting rolls 693 and the pair of paper transporting rolls 659 by respective amounts equal to the amounts of misregistration, detected by the first and second detectors 77 and 85, of the recording paper 5 in the direction intersecting the direction of transport.

In the paper transporting device 60 according to the present exemplary embodiment, however, the control device 100 determines the amounts of shifting of the pair of paper transporting rolls 693 and the pair of paper transporting rolls 659 in such a manner as to shift the pair of paper transporting rolls 693 and the pair of paper transporting rolls 659 by respective amounts obtained by multiplying the amounts of misregistration, detected by the first and second detectors 77 and 85, of the recording paper 5 in the direction intersecting the direction of transport by a correction factor, not in such a manner as to shift the pair of paper transporting rolls 693 and the pair of paper transporting rolls 659 by respective amounts equal to the amounts of misregistration, detected by the first and second detectors 77 and 85, of the recording paper 5 in the direction intersecting the direction of transport.

What determines the correction factor is any of the characteristics that affect the position of the recording paper 5 in the direction intersecting the direction of transport; specifically, at least one of the length of the recording paper 5 in the direction of transport and/or the direction intersecting the direction of transport, the basis weight of the recording paper 5, the material of the recording paper 5, and the mode of image formation to be performed on the recording paper 5.

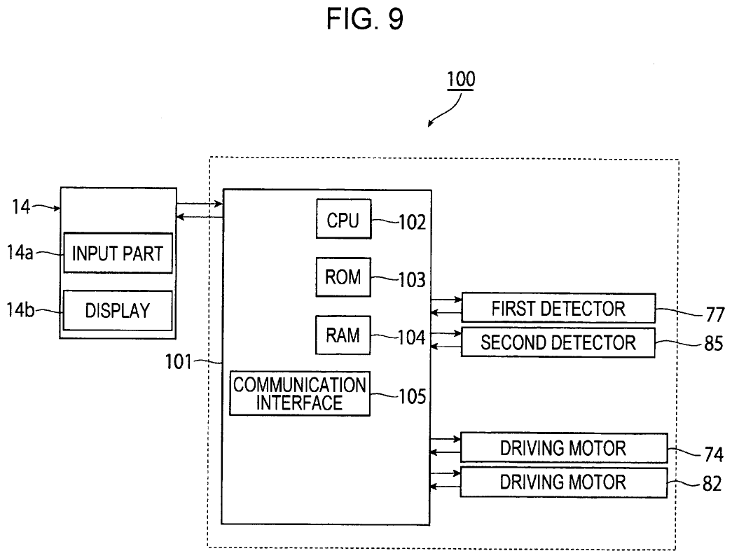

FIG. 9 is a block diagram of the control device 100 included in the image forming apparatus 1.

The control device 100 illustrated in FIG. 9 includes a controller 101, which is an exemplary controlling component and is configured to generally control the operation of the image forming apparatus 1. The controller 101 includes a central processing unit (CPU) 102, which is configured to generally control the image forming operation and also serves as the changing component; a read-only memory (ROM) 103, which is configured to store control programs and the like to be executed by the CPU 102; a random access memory (RAM) 104, which is configured to store parameters and the like to be used in the control programs and the like to be executed by the CPU 102; buses (not illustrated) that connect the foregoing elements including the CPU 102 and the ROM 103 to one another; and a communication interface 105, through which the controller 101 communicates with devices such as an external personal computer and an image reading device.

The controller 101 receives from an input part 14a and a display 14b, which are included in an operation device 14, information such as the size and kind (including basis weight) of the recording paper 5 on which an image is to be formed, the number of copies to be printed, and the mode of image formation representing simplex printing, duplex printing, or the like. The controller 101 is configured to further control the driving motors 74 and 82, which are stepping motors or the like and are configured to move the pair of paper transporting rolls 693 and the pair of paper transporting rolls 659 with reference to relevant information including the detection signals transmitted from the detectors 77 and 85.

Information stored in the ROM 103 in advance includes the characteristics relevant to the transport of the recording paper 5, including the length of the recording paper 5 in the direction of transport and/or in the direction intersecting the direction of transport and the basis weight of the recording paper 5; and the correction factors to be employed in determining the amounts of shifting of the pair of paper transporting rolls 693 and the pair of paper transporting rolls 659 with reference to the characteristics relevant to the transport of the recording paper 5.

If the length of the recording paper 5 in the direction of transport is smaller than or equal to the length of the longer side of the recording paper 5 of size A3, the correction factor to be employed in determining the amount of shifting of the recording paper 5 by each of the pair of paper transporting rolls 693 and the pair of paper transporting rolls 659 is 1, which is stored as the normal value. If the length of the recording paper 5 in the direction of transport is greater than the length of the longer side of the recording paper 5 of size A3, the correction factor to be employed in determining the amount of shifting of the recording paper 5 by each of the pair of paper transporting rolls 693 and the pair of paper transporting rolls 659 is C1 (an integer greater than 1 or a decimal), which is stored as a predetermined correction factor different from the normal value.

In the latter case, the correction factor to be employed in determining the amount of shifting of the recording paper 5 by the pair of paper transporting rolls 693 and the pair of paper transporting rolls 659 is greater for the pair of paper transporting rolls 659 than for the pair of paper transporting rolls 693.

If the basis weight of the recording paper 5 is greater than the basis weight of plain paper, specifically greater than 200 gsm, the correction factor to be employed in determining the amount of shifting of the recording paper 5 by each of the pair of paper transporting rolls 693 and the pair of paper transporting rolls 659 is C2 (an integer greater than 1 or a decimal), which is stored as a predetermined correction factor different from the normal value.

If the recording paper 5 is any special paper such as embossed paper, the correction factor to be employed in determining the amount of shifting of the recording paper 5 by each of the pair of paper transporting rolls 693 and the pair of paper transporting rolls 659 is C3 (an integer greater than 1 or a decimal), which is stored as a predetermined correction factor different from the normal value.

### Functions of Paper Transporting Device

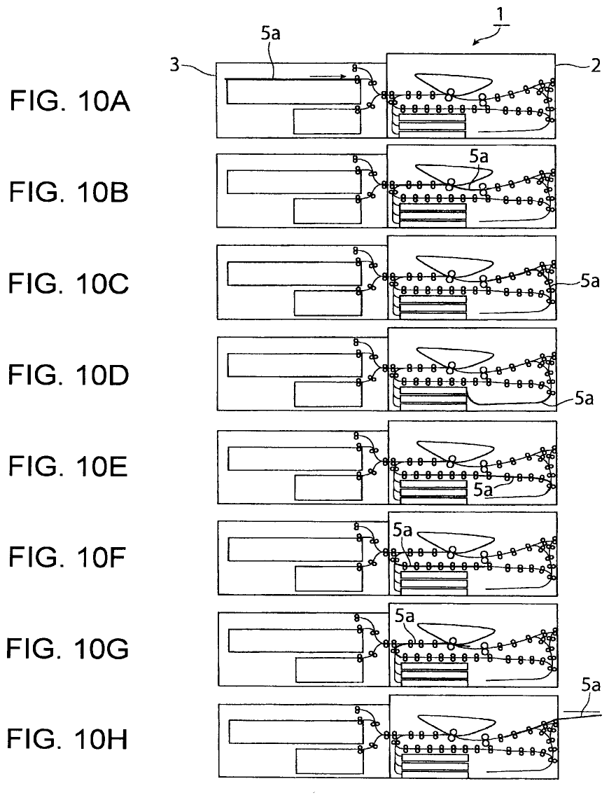

According to the present exemplary embodiment, in the process of forming an image on each of the two sides of any long-size paper 5a, the long-size paper 5a is fed from the paper feeding device 3 to the paper transporting device 60 as illustrated in FIG. 10A.

Accordingly, the control device 100 acknowledges that the recording paper 5 designated by the user is not plain paper but long-size paper 5a.

The long-size paper 5a fed from the paper feeding device 3 enters the image output device 2 and is transported along the external-paper feeding path 66 and the paper feeding path 61 in the paper transporting device 60 to the second-transfer position in the intermediate transfer device 20. In this process, referring to FIG. 2, the position of the long-size paper 5a in the direction intersecting the direction of transport is detected by the first detector 77 located on the upstream side relative to the pair of paper transporting rolls 693. If any misregistration of the long-size paper 5a in the direction intersecting the direction of transport is detected, the position of the long-size paper 5a is adjusted by the pair of paper transporting rolls 693, illustrated in FIG. 4.

Subsequently, after an image is formed and fixed on one side of the long-size paper 5a, as illustrated in FIGS. 10C to 10F, the long-size paper 5a is reversed by being transported along the outputting transport path 63 and the reversal transport path 64 and is transported to the duplex transport path 65.

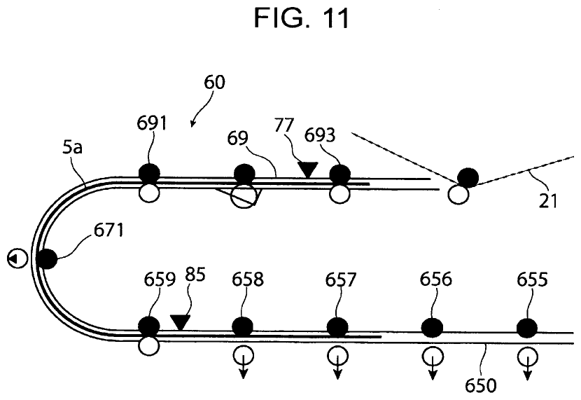

Referring to FIG. 11, the long-size paper 5a thus transported to the duplex transport path 65 is further transported to the pair of paper transporting rolls 657 and the pair of paper transporting rolls 658.

In this state, the pair of paper transporting rolls 658 is in the nipping position.

Subsequently, the control device 100 activates the pair of paper transporting rolls 658, the second detector 85 detects the amount of skew of the long-size paper 5a, and the control device 100 controls the pair of paper transporting rolls 658 to correct the skew of the long-size paper 5a.

Subsequently, referring to FIG. 2, the position of the long-size paper 5a in the direction intersecting the direction of transport is detected by the second detector 85 located on the upstream side relative to the pair of paper transporting rolls 659. If any misregistration of the long-size paper 5a in the direction intersecting the direction of transport is detected, the position of the long-size paper 5a is adjusted by the pair of paper transporting rolls 659, illustrated in FIG. 6.

Subsequently, referring to FIG. 2, the position of the long-size paper 5a in the direction intersecting the direction of transport is detected by the first detector 77 located on the upstream side relative to the pair of paper transporting rolls 693, and the position of the long-size paper 5a in the direction intersecting the direction of transport is also detected by the second detector 85 located on the upstream side relative to the pair of paper transporting rolls 659.

If at least one of the first detector 77 and the second detector 85 detects any misregistration of the long-size paper 5a in the direction intersecting the direction of transport, the control device 100 determines the amount of shifting of a corresponding one of the pair of paper transporting rolls 693 and the pair of paper transporting rolls 659 by multiplying the amount of misregistration detected by the at least one of the first detector 77 and the second detector 85 by the correction factor C1.

Thus, in the paper transporting device 60 according to the present exemplary embodiment, the amount of shifting is changed individually for the pair of paper transporting rolls 693 and the pair of paper transporting rolls 659 by multiplying the amount of shifting of each of the pair of paper transporting rolls 693 and the pair of paper transporting rolls 659 by a correction factor employed with reference to any of the characteristics relevant to the transport of the recording paper 5. Therefore, even if the recording paper 5 is long-size paper 5a having a greater length in the direction of transport, an appropriate amount of shifting for the correction of misregistration of the long-size paper 5a is obtained for each of the pair of paper transporting rolls 693 and the pair of paper transporting rolls 659.

While the above exemplary embodiment relates to an image forming apparatus configured to form a full-color image, the application of the exemplary embodiment is not limited thereto. The above exemplary embodiment may be applied in the same way to an image forming apparatus configured to form a monochrome image.

While the above exemplary embodiment relates to a case where the sheet transporting device is applied to a paper transporting device intended for an image forming apparatus, the application of the sheet transporting device is not limited thereto. The sheet transporting device may be applied in the same way to a device intended for any printing apparatus or the like other than the image forming apparatus, as long as the device is configured to transport a sheet. The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A sheet transporting device comprising:
first and second position correcting components provided at respective positions in a direction of sheet transport and each being configured to correct a position of a sheet in a direction intersecting the direction of sheet transport by being shifted in the direction intersecting the direction of sheet transport while holding the sheet; and
a changing component capable of changing an amount of correction of the position of the sheet individually for the first and second position correcting components.

(((2)))

The sheet transporting device according to (((1))),
wherein the changing component changes the amount of correction of the position of the sheet individually for the first and second position correcting components by multiplying an amount of shifting of each of the first and second position correcting components in the direction intersecting the direction of sheet transport by a correction factor.

(((3)))

The sheet transporting device according to (((2))),
wherein the correction factor to be employed by the changing component is greater for one of the first and second position correcting components that is located on a downstream side in the direction of sheet transport than for an other located on an upstream side in the direction of sheet transport.

(((4)))

The sheet transporting device according to (((1))),
wherein the changing component changes the amount of correction of the position of the sheet individually for the first and second position correcting components with reference to a characteristic relevant to sheet transport.

(((5)))

The sheet transporting device according to (((4))),
wherein the characteristic relevant to sheet transport to be referred to by the changing component in changing the amount of correction of the position of the sheet individually for the first and second position correcting components includes at least one of a length of the sheet in the direction of sheet transport, a basis weight of the sheet, a material of the sheet, and a mode of sheet transport.

(((6)))

The sheet transporting device according to (((5))),
wherein the amount of correction of the position of the sheet that is determined by the changing component for each of the first and second position correcting components is greater for a greater basis weight of the sheet.

(((7)))

An image forming apparatus comprising:
an image forming component configured to form an image on a sheet; and
a sheet transporting component configured to transport the sheet,
wherein the sheet transporting component is the sheet transporting device according to any of (((1))) to (((6))).

What is claimed is:

1. A sheet transporting device comprising:
first and second position correcting components provided at respective positions in a direction of sheet transport and each being configured to correct a position of a sheet in a direction intersecting the direction of sheet transport by being shifted in the direction intersecting the direction of sheet transport while holding the sheet; and
a changing component capable of changing an amount of correction of the position of the sheet individually for the first and second position correcting components.

2. The sheet transporting device according to claim 1,
wherein the changing component changes the amount of correction of the position of the sheet individually for the first and second position correcting components by multiplying an amount of shifting of each of the first and second position correcting components in the direction intersecting the direction of sheet transport by a correction factor.

3. The sheet transporting device according to claim 2,
wherein the correction factor to be employed by the changing component is greater for one of the first and second position correcting components that is located on a downstream side in the direction of sheet transport than for an other located on an upstream side in the direction of sheet transport.

4. The sheet transporting device according to claim 1,
wherein the changing component changes the amount of correction of the position of the sheet individually for the first and second position correcting components with reference to a characteristic relevant to sheet transport.

5. The sheet transporting device according to claim 4,
wherein the characteristic relevant to sheet transport to be referred to by the changing component in changing the amount of correction of the position of the sheet individually for the first and second position correcting components includes at least one of a length of the sheet in the direction of sheet transport, a basis weight of the sheet, a material of the sheet, and a mode of sheet transport.

6. The sheet transporting device according to claim 5,
wherein the amount of correction of the position of the sheet that is determined by the changing component for each of the first and second position correcting components is greater for a greater basis weight of the sheet.

7. An image forming apparatus comprising:
an image forming component configured to form an image on a sheet; and
a sheet transporting component configured to transport the sheet,
wherein the sheet transporting component is the sheet transporting device according to claim 1.

8. An image forming apparatus comprising:
an image forming component configured to form an image on a sheet; and
a sheet transporting component configured to transport the sheet,
wherein the sheet transporting component is the sheet transporting device according to claim 2.

9. An image forming apparatus comprising:
an image forming component configured to form an image on a sheet; and
a sheet transporting component configured to transport the sheet,
wherein the sheet transporting component is the sheet transporting device according to claim 3.

10. An image forming apparatus comprising:
an image forming component configured to form an image on a sheet; and
a sheet transporting component configured to transport the sheet,
wherein the sheet transporting component is the sheet transporting device according to claim 4.

11. An image forming apparatus comprising:
an image forming component configured to form an image on a sheet; and
a sheet transporting component configured to transport the sheet,
wherein the sheet transporting component is the sheet transporting device according to claim 5.

12. An image forming apparatus comprising:
an image forming component configured to form an image on a sheet; and
a sheet transporting component configured to transport the sheet,
wherein the sheet transporting component is the sheet transporting device according to claim 6.

13. A sheet transporting device comprising:
first and second position correcting means for correcting a position of a sheet that are provided at respective positions in a direction of sheet transport and are each configured to correct a position of the sheet in a direction intersecting the direction of sheet transport by being shifted in the direction intersecting the direction of sheet transport while holding the sheet; and
changing means for changing an amount of correction of the position of the sheet individually for the first and second position correcting means.
